(19) United States
(12) Patent Application Publication
(10) Pub. No.: US 2007/0185747 A1
(43) Pub. Date: Aug. 9, 2007

(54) Business process assistance wizard

(75) Inventors: Prashant Gupta, Rajasthan (IN); Abhijit Gore, Mumbai (IN); Amit Kumar, Agra (IN); Kulothungan Rajasekaran, Hyderabad (IN); Derik B. Stenerson, Redmond, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/348,562

(22) Filed: Feb. 7, 2006

(51) Int. Cl. G06F 9/44

(52) U.S. Cl. 705/7

(57) ABSTRACT

A business process guide may assist tracking and updating business processes, such as marketing business processes. The business processes may be part of a customer relationship management system. High level business process elements may be displayed which may be selected to display additional information about the elements.

### BACKGROUND

Business processes, such as marketing business process, often have multiple steps and require significant coordination among multiple people and groups. Keeping track that tasks have been assigned and completed is a challenging task. In addition, smoothly integrating a system that tracks business process with tools necessary to execute the necessary business process elements has been a challenge. Moreover, not every business process is the same so a standard business process may not be adaptable to every situation.

### SUMMARY

A business process guide may assist tracking and updating business processes, such as marketing business process. High level business process elements may be displayed which may be selected to display additional information about the elements. The elements and additional detail may be modified by the user and these changes may be available to the other members of the business process. Changes made at the detail level may be displayed at the high level as elements to be selected.

### DRAWINGS

FIG. 1 is a block diagram of a computing system that may operate in accordance with the claims;

FIG. 2 is an illustration of a flowchart in accordance with the claims of the invention;

FIG. 3 is an illustration of a business process guide user interface;

FIG. 4 is an illustration of a detailed business process guide user interface;

FIG. 5a is an illustration of additional plan phase details;

FIG. 5b is an illustration of additional prepare phase details;

FIG. 5c is an illustration of additional launch phase details; and

FIG. 5d is an illustration of additional monitor phase details.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

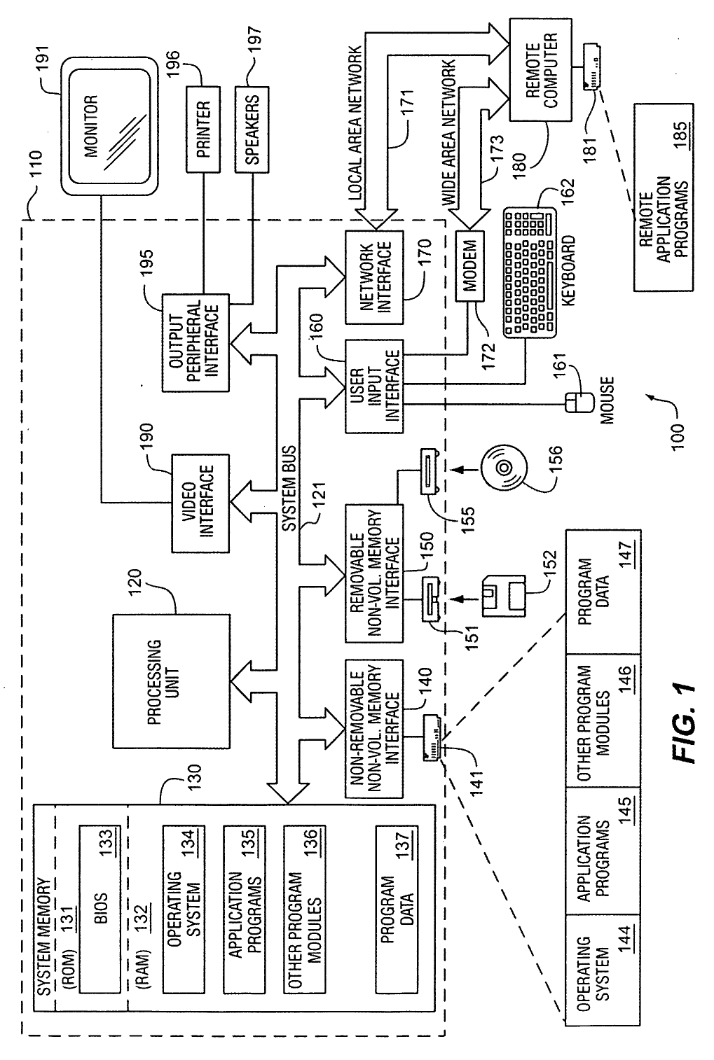

FIG. 1 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

The steps of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and apparatus may be described in the general context of computer-executable instructions, such as program modules, being executed by a computer. Generally, program modules include routines, programs, objects, components, data structures, etc. that perform particular tasks or implement particular abstract data types. The methods and apparatus may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the steps of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

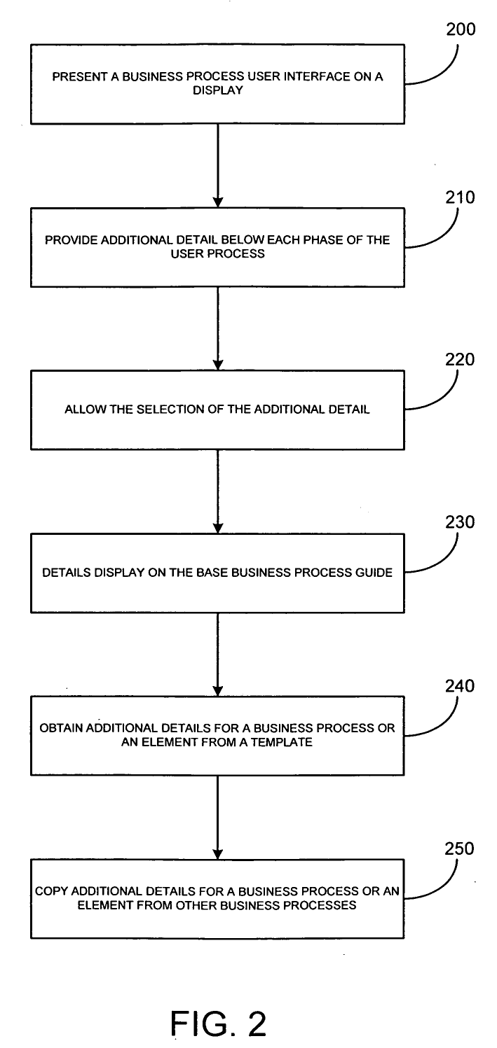

FIG. 2 may be an illustration of a flowchart of a method of assisting users through a business process or campaign using a business process guide. The method may be computer executable blocks that may be stored on and read from a computer readable medium such as hard disk drive 140 that reads from or writes to non-removable, nonvolatile magnetic media, a magnetic disk drive 151 that reads from or writes to a removable, nonvolatile magnetic disk 152, or an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The business process may be a marketing business process, for example, such as a business process to get current customer to increase purchasing or a business process to notify customers of a special sale.

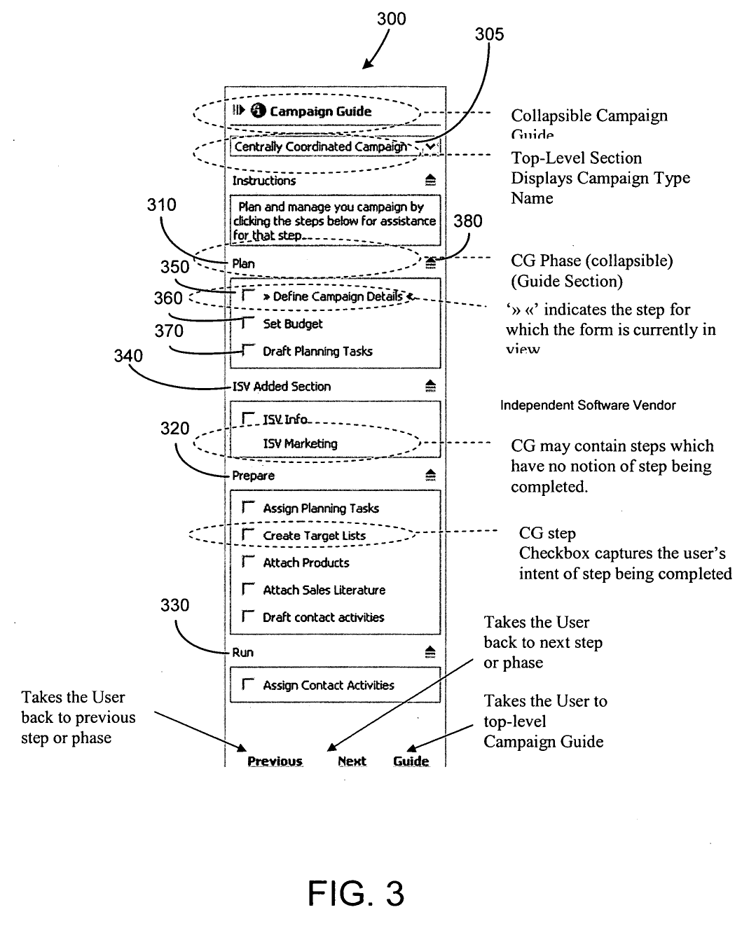

At block 200, the method may present a business process user interface on a display with phases of the business process displayed comprising planning, preparation, launch and monitor. FIG. 3 may be a sample illustration of a business process guide 300. In FIG. 3, several parts of the business process may be displayed such as plan 310, prepare 320 and run 330. Additional business process elements may be added to business process depending on the type of business process. For example, if the business process is to launch new software, having independent software vendors (“ISV”) write software to use the software may be of great importance. Accordingly, an element may be added for ISVs 340. The number and type of additional elements that may be added to a business process are virtually limitless. Sample business process types 305 may be centrally coordinated business processes, field based business processes based on a template, field based business processes not based on a template, direct email blast business processes and generic business processes.

Referring again to FIG. 2, at block 210, the method may provide additional detail below each phase of the business process where the additional detail is obtained by selecting the displayed business process phase. Referring again to FIG. 3, by selecting the phase “plan” 310, additional details about the plan may be obtained, such as “Define Business process Details” 350, “Set Budget” 360 and “Draft Planning Tasks” 370. In FIG. 3, the section below “plan” 310 may be collapsed by selecting the collapse button 380.

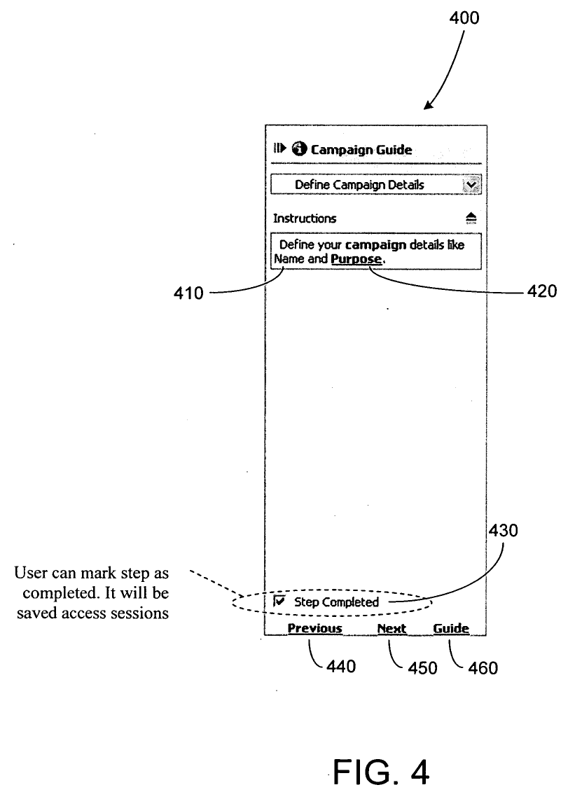

At block 220 of FIG. 2, the method may allow the selection of the additional detail and opening in another window on the display a related form to the selected additional detail. For example, in FIG. 3, “Define Business process Details” 350 may be selected (indicated by the surrounding arrows >>. . . <<) which may result in the opening of another window 400 such as illustrated in FIG. 4. In FIG. 4, additional details about a business process may be added such as the business process name 410 and business process purpose 420. The method may automatically use the proper software to display the additional detail. For example, if the additional detail is an Excel® file that needs to be completed, the Excel file may open or if the detail is part of a customer relationship management (CRM) system such as Microsoft CRM, the CRM system may start. If the necessary application is not recognized, the method may ask the user to select the proper application.

At block 230 in FIG. 2, when additional details are added in this separate form 400 (FIG. 4), the details may appear on the base business process guide 300 (FIG. 3). For example, say “set budget” 360 was selected and additional details were added such as “fill our requisition form”, “draft purpose and need statement” and “create cost accounting projection” were added. These elements may then appear on the business process guide 300 under “set budget” 360.

At block 240 in FIG. 2, additional details for a business process or an element may be obtained from a template. The template may be generated internally or externally. For example, outside marketers may create template of things to do, include calling the outside marketer for help on certain items.

At block 250, additional details for a business process or an element may be copied from other business process. For example, if a previous business process had extensive planning techniques and the business process was especially successful, it may make sense to copy the planning from the previous business process.

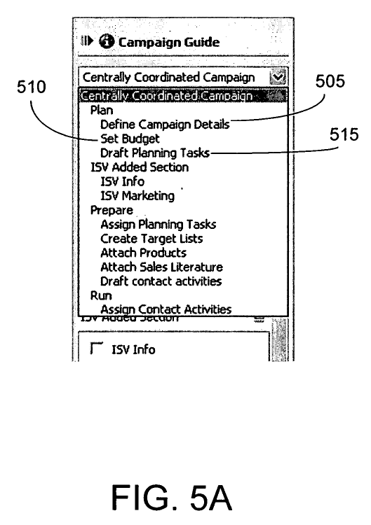

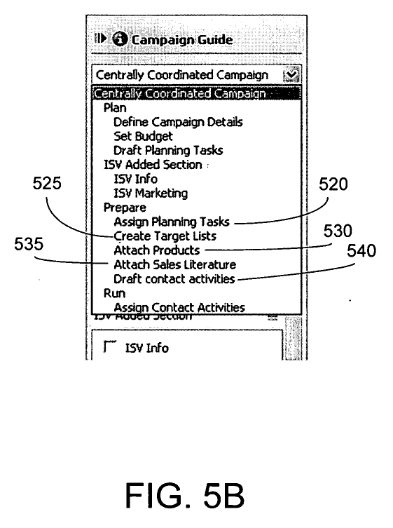

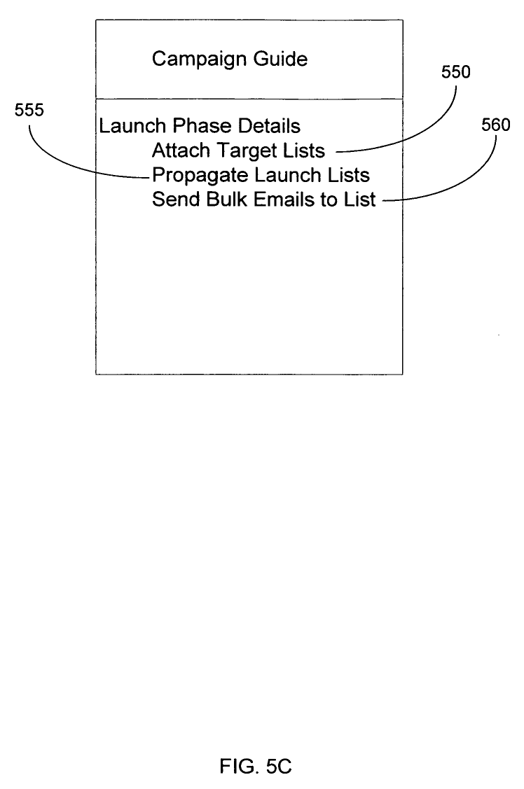

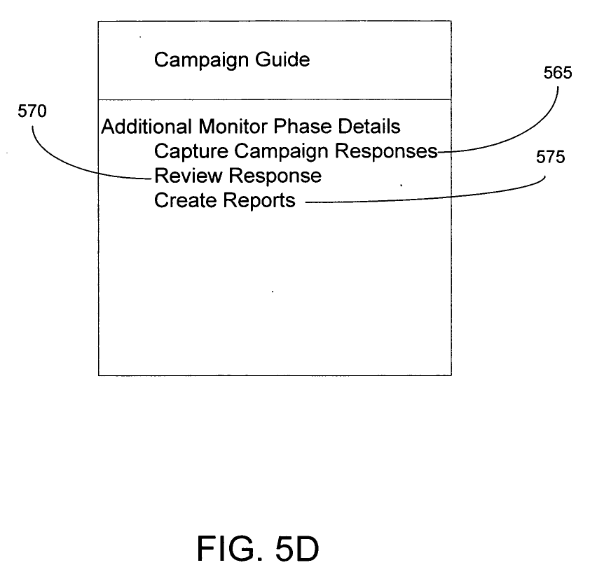

FIG. 5a may illustrate some of the additional plan phase details. Some example may include defining business process details 505, defining budget and schedule 510 and drafting planning task 515. These details may have even more sub-details and the sub-details may have sub-sub-details, etc.

FIG. 5b may illustrate some examples of additional prepare phase details. Some examples may include assigning planning tasks 520, creating target lists 525, attaching products 530, attaching sales literature 535, drafting contact activities 540 and notifying sales 545.

FIG. 5c may illustrate some examples of additional launch phase details. Some examples may include attaching target lists 550, propagating launch lists 555 and sending bulk emails to the lists 560. Use of a powerful CRM system such as Microsoft CRM may make creating such lists as easy as a point and a click using a mouse.

FIG. 5d may illustrate some examples of additional monitor phase details. Some examples may include capturing business process responses 565, reviewing responses 570 and creating reports based on the business process 575.

At block 260 of FIG. 2, the method may allow an indication that the additional detail below each phase of the business process is complete. For example, in FIG. 4, the “step completed” box may be checked 430. This box may be checked even if this step has not been undertaken. This may be useful when a business process is copied from a previous business process and some elements of the previous business process may not be applicable. Accordingly, instead of those items appearing to be incomplete, a user may mark them as complete 430. In addition, a user may select to see the previous element of the business process 440, the next window of the business process 450 or return to the main business process guide 460.

At block 270 of FIG. 2, the business process user interface 300 (FIG. 3) may be minimized while a user works on the business process. For example, say the user has to create a profitability analysis for a project. This may require use of a spreadsheet such as Microsoft Excel®. While the use of Excel® is driven by the business process manager, there may be no need to have the business process manager 300 displayed while working on Excel®. Accordingly, the business process guide 300 may be completely closed or minimized.

In addition, business processes often require numerous people. At block 280 of FIG. 2, the method may allow any of the members of the business process with the proper level of authority to mark a step as being complete 430 (FIG. 4). In addition, the steps of the business process do not necessarily have to be completed in the order in which they are listed in FIG. 3. For example, if ISV 340 have no role in a business process, all the elements under ISV may be selected as being completed even before planning 310 tasks may be started.

At block 290 of FIG. 2, the changes to a business process may be stored. The storage may be in a single file that is accessed by multiple users such that all the users may keep track on the most recent progress on a project. The project may be accessed remotely and users with the proper permissions can modify and store changes to the business process.

The changes to the business process may also be made by a third party independent service provider. The changes do not necessarily have to be accomplished in house. The third party may customize the whole guide via a properly prepared XML or a configuration file or by using the guide/wizard.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A method of providing guidance through a business process lifecycle, comprising:
presenting a business process user interface on a display with phases of the business process displayed comprising planning, preparation, launch and monitor;
providing additional detail below each phase of the business process where the additional detail is obtained by selecting the displayed business process phase; and
allowing selection of the additional detail and opening a related form to the selected additional detail in another window on the display.

2. The method of claim 1, further comprising allowing an indication that the additional detail below each phase of the business process is complete.

3. The method of claim 1, further comprising saving the changes made to the related forms and the completed phases.

4. The method of claim 1, further comprising allowing an additional user to use the user interface and participate in the business process.

5. The method of claim 1, further comprising allowing the steps of the business process to be completed in a non-sequential order.

6. The method of claim 1, further comprising displaying items created in the related forms on the additional details.

7. The method of claim 1, further comprising obtaining additional details from a template.

8. The method of claim 1, further comprising allow a business process to copy selections from other business processes.

9. The method of claim 1, further comprising minimizing the business process user interface while working on the business process.

10. The method of claim 1, wherein additional plan phase details comprise:
defining business process details,
defining budget and schedule; and
drafting a planning task.

11. The method of claim 1, wherein additional prepare phase details comprise:
assigning planning tasks;
creating target lists;
attaching products;
attaching sales literature;
drafting contact activities; and
notifying sales.

12. The method of claim 1, wherein launch phase details comprise:
attaching target lists;
propagating launch lists; and
sending bulk emails to the lists.

13. The method of claim 1, wherein the monitor phase details comprise:
capturing business process responses;
reviewing responses; and
creating reports based on the business process.

14. The method of claim 1, wherein business processs comprise at least one of:
centrally coordinated business process;
field based business process based on a template;
field based business process not based on a template;
direct email blast business process; and
generic business process.

15. A computer readable medium with computer executable instructions, wherein the computer executable instructions comprise:
presenting a business process user interface on a display with phases of the business process displayed comprising planning, preparation, launch and monitor;
providing additional detail below each phase of the business process where the additional detail is obtained by selecting the displayed business process phase;
allowing selection of the additional detail and opening a related form to the selected additional detail in another window on the display; and
allowing an indication that the additional detail below each phase of the business process is complete.

16. The method of claim 1, further comprising allowing an additional user to use the user interface and participate in the business process.

17. The method of claim 1, further comprising obtaining additional details from a template or from a previous business process.

18. A computer system comprising a processor, a memory and an input/output circuit wherein the memory stores computer executable code to be executed by the processor, the computer executable code comprising code for:
presenting a business process user interface on a display with phases of the business process displayed comprising planning, preparation, launch and monitor;
providing additional detail below each phase of the business process where the additional detail is obtained by selecting the displayed business process phase;
allowing selection of the additional detail and opening a related form to the selected additional detail in another window on the display;
allowing an indication that the additional detail below each phase of the business process is complete; and
minimizing the business process user interface while working on the business process.

19. The computer system of claim 18, further comprising computer executable instructions for allowing an additional user to use the user interface and participate in the business process.

20. The computer system of claim 18, further comprising computer executable instructions for obtaining additional details from a template or from a previous business process
